(19) United States
(12) Patent Application Publication
(10) Pub. No.: US 2007/0089090 A1
(43) Pub. Date: Apr. 19, 2007

(54) Method and system for protecting source code

(75) Inventors: Wolfgang Riedl, Nurnberg (DE); Christian Stromsdorfer, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/527,215

(22) Filed: Sep. 26, 2006

(30) Foreign Application Priority Data
Sep. 26, 2005 (DE) 10 2005 045 852.1

(51) Int. Cl. G06F 9/44

(52) U.S. Cl. 717/120

(57) ABSTRACT

The present invention relates to a method and a system for protecting source code, in particular source code containing intellectual property. Managed source code which is to be protected is deflected into a module in which native code is created for the source code. In addition, native facades are created for all the modules referenced with the module and a managed facade for the module with the native code.

### CROSS REFERENCE TO RELATED APPLICATIONS

This application claims priority of German application No. 102005045852.1 DE filed Sep. 26, 2005, which is incorporated by reference herein in its entirety.

### FIELD OF INVENTION

The present invention relates to a method and a system for protecting source code. In particular, the present invention relates to providing effective protection of intellectual property in software products.

### BACKGROUND OF INVENTION

For companies that are significant competitors in a specific market segment comprising extensive software systems, it is of fundamental interest to protect the intellectual property contained in the software systems. In general not all parts of a software environment contain technical expertise or knowledge requiring effective protection. Reverse engineering of source code may be of interest to various groups involved in the product life cycle.

For example, a customer might be tempted to reverse-engineer the software product in order to make his own modifications and enhancements to that product. This may not only result in a difficult support situation but also in losing the customer altogether if he no longer requires any updates or new versions of the software product.

In addition, a competitor may be interested in discovering algorithms which appear to work better in one of his products, in order then to incorporate them in his own product and/or combine them with his own algorithms, the aim usually being to achieve a greater market share.

Moreover, a malicious programmer (e.g. hacker) may be interested in discovering possible errors in the design of the software product in order then to be able to attack that product. Sometimes this may also be of interest to a competitor.

These examples underscore the importance of protecting know-how in software algorithms.

Before the advent of new software development technologies, providing know-how protection in software products was not a priority, as conventionally used compilers such as C++ compilers generated at least difficult to read and optimized machine code. Reverse engineering of source code was therefore not profitable, which meant that source code was automatically protected.

Generally, however, software products are now developed using mainly new technologies such as Java and .NET Framework and new managed environments are employed on all essential computer platforms. In a managed environment, three main areas which were hitherto contained in each software module of a software product are managed by a runtime machine.

Memory management allocates memory when requested by a module and what is known as a garbage collector automatically frees up memory which is allocated but cannot be accessed by a module. This is not only very efficient, but in many cases even faster than native mechanisms for managing memory which are used, for example, in programming languages such as C and C++.

In addition, modules of the software product contain no native machine code instructions but a somewhat abstract intermediate code. This is not converted into native code until the application is loaded onto a target system, thereby enabling characteristics of the target system to be much better utilized. Thus, for example, different optimizations can be performed depending on the amount of memory available or on the basis of the modules already loaded. The runtime machine checks the code to be executed so that, for example, it is not executed if execution would result in a crash or a security violation. Native, executable code is created using a just-in-time (JIT) compiler. A just-in-time compiler generates, at program runtime, native code optimized to the base machine from any intermediate code.

In addition, the runtime machine manages peculiarities of particular operating systems and/or processor architectures. As the native code is not created until loading on a target system, neither the original source code nor the intermediate code contain native machine code instructions, which means that the native code is platform and processor independent. However, the peculiarities of the operating systems and/or processor architectures must be handled by the runtime machine, which means that the latter is both platform and processor dependent.

Because of their advantages compared to conventional technologies, the managed environments will in future be used as primary development platforms.

For example, managed code such as Java or C# code is easier to write, maintain and understand. Furthermore, as already described, memory is managed automatically. As when developing native code the majority of errors occur in memory management, automatic memory management in managed environments in particular provides advantages in terms of development time, easier debugging (eliminating errors in the code), maintenance and security. In addition, managed compilation units are platform and processor independent.

Moreover, major companies involved in developing operating systems reject the future use of development systems which produce native code. For example, Microsoft is pushing NET Framework and companies such as Sun and IBM Java. This means in particular that companies which use software in conjunction with the operating systems of these companies may be forced to use these new technologies (e.g. NET Framework, Java) at least for the majority of their products.

However, the advantages of Java and .NET Framework have an attendant disadvantage, particularly in terms of protecting intellectual property in software products.

Both Java and NET code are not compiled into native machine code but into an intermediate code similar to an assembler, said intermediate code being mapped deterministically to the original Java or .NET code. It is therefore very easy to reverse-engineer, which typically means that intellectual property cannot be effectively protected. There are even tools such as “Reflector for .NET” http://www.aisto.com/roeder/dotnet/) which restore the underlying C# or Visual Basic code merely by double-clicking.

### SUMMARY OF INVENTION

Different proposals for solving the problem of protecting source code have been put forward, but none of these proposals is in any way satisfactory.

For example, it has been proposed to encode components to be protected in C++ and compile them into machine code. However, it is precisely these components that become the most error-prone modules, as the already described problems with regard to native programming (e.g. memory management) remain.

It has also been proposed to obfuscate the source code of the components to be protected by removing the corresponding identifiers of assembler tokens and replacing them by gibberish. However, known obfuscations merely slow down the reverse engineering process, which means that the source code e.g. constituting intellectual property is not effectively protected.

It has additionally been proposed to encrypt the source code, in order to mislead a disassembler. For example, it has been proposed to encrypt an entire module containing the source code to be protected. However, the problem with encryption is that the decryption algorithm must be available at runtime. It is therefore only a matter of time before the mechanisms are discovered or the decrypted source code intercepted. In particular, decryption of all the components to be protected will be achieved as soon as one component is successfully decrypted.

It has additionally been proposed to perform pre-compilation of a module containing the source code to be protected, said module being pre-compiled into native code by linking the module code and all the referenced modules to a monolithic native component. However, this means losing, for example, the advantages of a Java or NET environment, as each service pack or each new version may result in the monolith no longer running. Moreover, following pre-compilation the module ceases to be a Java or .NET component and cannot therefore be used by other Java or .NET components.

Protecting intellectual property by means of patents, copyright or licenses is also insufficient to protect the intellectual property from e.g. malicious use. Reverse engineering will always be of interest to certain groups, for which reason technical solutions for protecting know-how are essential.

An object of the present invention is therefore to provide a more effective method and system for protecting source code compared to conventional methods and systems, particularly source code containing intellectual property.

This object is achieved by a method and a system as claimed in the independent claims. Advantageous embodiments and further developments of the invention are set forth in claims dependent thereon.

According to the invention, to protect source code in a module a native facade for modules referenced with the module is created. For the source code of the module there is additionally created a native code which establishes a link to the native facades of the referenced modules. This enables managed interfaces of the referenced modules to be called by the native code. As a native code is created for the source code of the module, the module now becomes a native component and contains only machine code. In addition, a managed facade is created for the module in order to make it accessible to other managed modules and keep its metadata intact. The metadata is particularly necessary in order to hold a NET runtime environment together. This step ensures that the module looks like a managed module and all public interface calls are redirected to the native code which is already present after the preceding step.

In the context of the invention the term “facade” is to be understood as a kind of envelope which mimics all the objects and functions of a particular environment for another environment. This means that all the managed environments are callable for native objects and vice versa. All the managed environments offer a multiplicity of ways of creating such facades.

Effective source code protection is therefore achieved by a method which in the context of the invention is termed deflection, a component which contains the part of the software product to be protected in the form of source code being deflected in such a way that the protection is achieved by means of a native code and, in addition, all the advantages of the new managed programming and runtime environments described in the introduction being retained. As the component incorporating the source code to be protected is deflected into a native component containing only unreadable machine code, the present invention provides effective source code protection.

A particularly advantageous feature of the method according to the invention is that no native programming is necessary, so that the disadvantages described in the introduction are avoided (e.g. memory management), the method according to the invention being particularly suitable for use in a managed environment, i.e. the runtime environment manages memory for the developer. The developer does not need either to allocate or deallocate memory, all this is done by the garbage collector. In addition, the developer can use virtually any managed programming language depending on his tasks. In general virtually every programming language can be used, depending on which managed environment is employed.

A further advantage with regard to the method according to the invention is that reverse engineering is very difficult or impossible, as it is non-deterministic. In the context of the invention the term “deterministic reverse engineering” is used if one-to-one mapping between the source code and the compiled code is present, the term “source” code referring, in the context of the invention, not to the precise wording of the original source code files but rather to the algorithmic structure.

In one embodiment, the method according to the invention includes the additional step of debugging, wherein debugging information is redirected such that a developer is guided by the original source code when removing errors from the component. This is necessary, as the debugging information of the native module is different from the debugging information which would have been created by a managed compiler.

The inventive deflection of the component differs from hitherto used methods particularly in that it operates at the level of the programming language used. The methods used hitherto operate at the level of an intermediate language in order to protect source code. The hitherto used methods would not be able to perform the inventive deflection, as the component used for obfuscation, encryption or the like is not the component developed by the programmer. Rather it contains the intermediate code, which means that system tests may be very risky and prone to error. Moreover, the debugging step is not possible using the methods employed hitherto.

### BRIEF DESCRIPTION OF THE DRAWINGS

Further features and advantages of the invention will emerge from the following description of different inventive exemplary and alternative embodiments with reference to the accompanying drawings in which:

FIG. 1 shows the architecture of the method according to the invention;

FIG. 2 shows how the various parts of the architecture illustrated in FIG. 1 are created by means of standard tools and using a translator; and

FIG. 3 shows the use of an intermediate language in creating the architecture illustrated in FIG. 1 and the modifying of debugging information according to the original source code language.

### DETAILED DESCRIPTION OF INVENTION

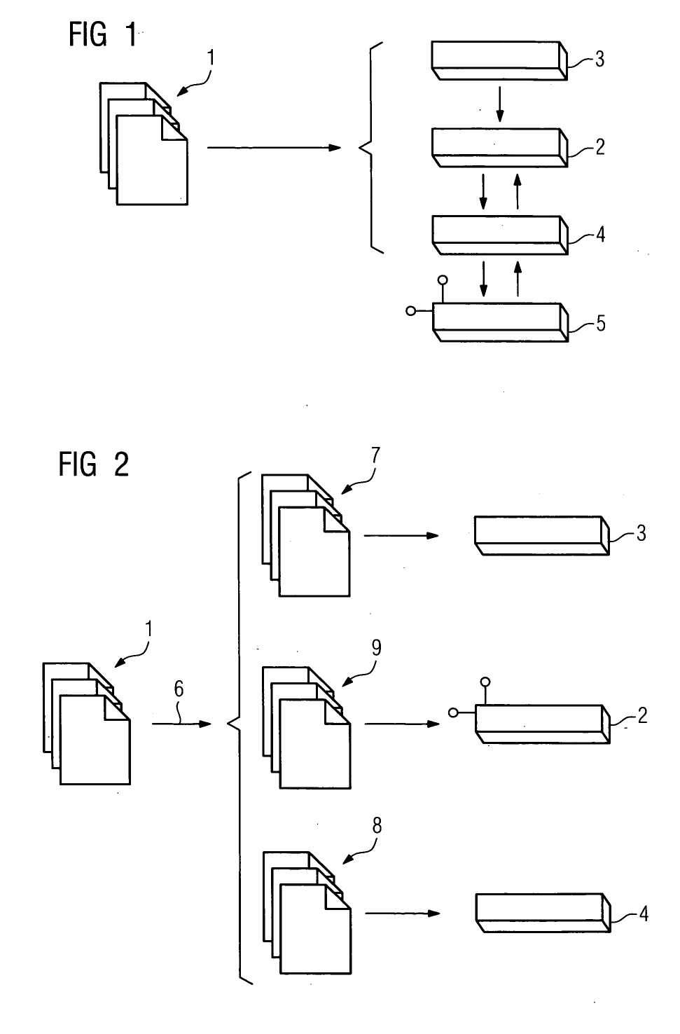

FIG. 1 shows the architecture of the method according to the invention. The main features of the architecture are the protection of managed source code 1 by native code 2 and two facades. The bracket in FIG. 1 indicates that a native facade 3, the native code 2 and a managed facade 4 are combined to form a module. However, is also possible for the native facades of different modules and the managed facade 4 to be in different modules from the native code 2. The question as to where the facades 3, 4 and the native module 2 are located is mainly dependent on the tools used for the method according to the invention. For Java, the facades must be in different modules from the native code, as Java does not support mixed modules. With .NET and the Microsoft C++ compiler it is possible to put all the parts in one module. If other C++ compilers such as GNU or the Intel C++ compiler are used, the facades and the native code must be separated as in the Java model.

The two facades 3, 4 provide everything required by the module with native code 2 so that this module appears as a managed module which can communicate with other managed modules 5, the present invention providing effective protection of the original source code 1 in which intellectual-property is preferably incorporated, as the original source code 1 is deflected into an unreadable native code. Said deflection is illustrated in FIG. 1 by the arrow between the managed source code 1 and the module indicated by the bracket. In addition, by creating the native facade 3 for the modules referenced with the module containing the native code 2, and creating the managed facade 4 for the module, all the advantages of the new managed environments mentioned in the introduction can be used. These provide simpler coding and error correction, the unrestricted use of the managed environments and seamless integration with other managed components 5 (whether or not deflected).

Although a compiled, deflected module is not binary compatible across platforms and processor architectures, i.e. the module must be compiled for each of same, virtually no software provider will actually use a binary source for more than one operating system and/or processor architecture. In addition, a compiled, deflected module has the advantage over genuine native components that the source code of the deflected module is completely platform and processor independent.

With regard to the present invention, a developer can use managed programming languages offering much higher productivity or far fewer possibilities of producing errors in the source code. The only need to change to complex programming languages such as C++ is if a managed environment is technically incapable of carrying out a particular task. Selecting the development environment therefore remains a purely technical matter.

Moreover, the module created by the developer is not re-handled, i.e. system testers and customers work with the modules which were actually developed and not with any garbled code. This also means that the module with the original source code can be debugged.

The module created using the method according to the invention behaves like a normal managed module, although actually only the facade 4 of the module is managed, the inside of the module remaining native and unreadable. Therefore, in contrast to conventional methods, it does not behave like any kind of monolith or statically linked module.

FIG. 2 shows a possible process for creating the different parts of the architecture shown in FIG. 1 which are used for setting up a deflected module using standard tools. The only item which has to be created in this tool chain is a translator 6. The translator 6 creates a mixed source code 7, 8 for the facades 3, 4 and a native source code 9 for the native module 2. Redirection of the debugging information can be performed using standard redirection mechanisms provided by mixed and native compilers.

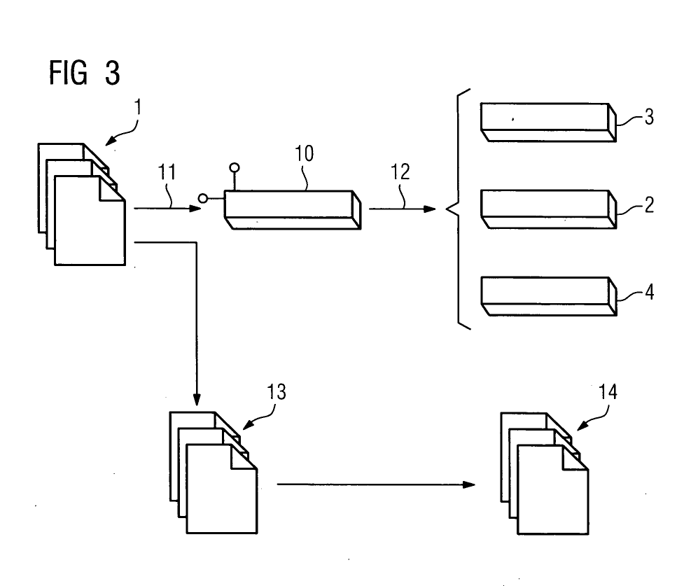

FIG. 3 shows an embodiment in which the two facades 3, 4 and the native code 2 are provided by using an intermediate language 10. A framework compiler 11 generates the intermediate language 10 from the managed source code 1 which can be present in any programming language supported by the framework. This intermediate language 10 is then used as input for generating the two facades 3, 4 and the native code 2, a first compiler 12 translating the intermediate code 10 into native code 2. In addition, another compiler modifies the debugging information 13 according to the original source code, knowledge of the underlying source code language being required if the debugging information is modified. The debugging information 13 is redirected to redirected debugging information 14.

An optimization step (not shown) can be performed if the managed source code of the module uses native code. As the managed source code must use some interop mechanism, this indirect route can be removed in the final native code. “Interop” is a .NET term for all the calls between managed and native components using standard mechanisms built into the managed runtime. A facade is also a type of interop mechanism, but is an adapted and optimized solution using no built-in functionality.

An even more precise approach could be to combine deflected and undeflected methods in one component. This can be achieved by future enhancements of the managed programming languages. For languages such as C# and C++ this means upgrading the ECMA standards of these languages. Languages such as Visual Basic .NET or Java must be upgraded according to the processes which are defined e.g. by the corresponding companies.

As native code possibly contains a richer functionality than managed code, further improvements can be built into the solution according to the invention. This can result e.g. in deflected modules which run at least as quickly as conventional managed modules and in certain scenarios the deflected components will run even quicker (e.g. if the managed source code makes extensive use of many remaining native components).

1-10. (canceled)

11. A method for protecting source code in a first module, comprising:
creating a native facade for a module referenced by the first module;
creating for the source code of the first module a native code that establishes a link to the native facade of the referenced module; and
creating a managed facade for the first module,
wherein the native code becomes a native component.

12. The method as claimed in claim 11, further comprises debugging using debugging information that is redirected in such a way that a developer is guided by the source code.

13. The method as claimed in claim 11, wherein the native facade, the native code, and the managed facade are created using a translator.

14. The method as claimed in claim 11, wherein the native facade, the native code and the managed facade are combined into one module.

15. The method as claimed in claim 1 1, wherein the native facade, and the managed facade are in a different module from the native code.

16. The method as claimed in claim 1 1, wherein the native facade, the native code and the managed facade are created from an intermediate code.

17. The method as claimed in claim 16, wherein the debugging information is modified according to an original source code language.

18. The method as claimed in claim 11, wherein the source code includes intellectual property.

19. The method as claimed in claim 11, wherein the method is used within a managed environment.

20. A system for protecting source code in a first module, comprising a native facade created for a plurality of modules referenced by the first module;
a native code that establishes a link to the native facades of the referenced module created for the source code of the first module; and
a managed facade created for the module,
wherein the native code becomes a native component.

21. The system as claimed in claim 20, wherein debugging information is redirected in such a way that a developer is guided by the source code.

22. The system as claimed in claim 21, wherein the native facades, the native code, and the managed facade are created using a translator.

23. The system as claimed in claim 22, wherein the native facades, the native code, and the managed facade are combined into one module.

24. The system as claimed in claim 23, wherein the native facades and the managed facade are in a different module from the native code.

25. The system as claimed in claim 24, wherein the source code includes intellectual property.

26. The system as claimed in claim 25, wherein the method is used within a managed environment.

27. The system as claimed in claim 23, wherein the native facade, the native code and the managed facade are created from an intermediate code.

28. The system as claimed in claim 27, wherein the debugging information is modified according to an original source code language.

29. The system as claimed in claim 28, wherein the source code includes intellectual property.

30. The system as claimed in claim 29, wherein the method is used within a managed environment.
